(19) United States
(12) Patent Application Publication
(10) Pub. No.: US 2026/0210791 A1
(43) Pub. Date: Jul. 23, 2026

(54) MULTI-LAYERED TUBULAR LEAK DETECTION

(71) Applicant: Nvidia Corporation, Santa Clara, CA (US)

(72) Inventors: Benjamin Goska, Portland, OR (US); Ryan Albright, Beaverton, OR (US); William Andrew Mecham, Elk Grove, CA (US); William Ryan Weese, Portland, OR (US); Aaron Carkin, Hillsboro, OR (US); Michael Thompson, Wilsonville, OR (US); Jordan Levy, Portland, OR (US)

(21) Appl. No.: 19/033,760

(22) Filed: Jan. 22, 2025

(51) Int. Cl. G01M 3/18; F16L 11/04; G01M 3/16

(52) U.S. Cl. CPC G01M 3/182; F16L 11/045; G01M 3/165

(57) ABSTRACT

Systems and methods are directed to a multi-layered tubular that can detect leaks. The multi-layered tubular can include sensing layers that generate an electrical signal in response to encountering a leak. The multi-layered tubular sends an electrical signal to a controller which can take responsive action. The controller may determine the location of the leak based on the electrical signal.

### TECHNICAL FIELD

At least one embodiment pertains to a multi-layered tubular. More specifically, at least one embodiment pertains to a multi-layered tubular with sensing layers capable of generating electrical signals indicating the presence of a leak.

### BACKGROUND

Data centers may contain a number of compute units, which may be arranged in a variety of configurations, such as rack-mounted systems that include rows of racks that include a number of different sets of compute units. Compute units generate heat units within a data center and are often configured to run within a given temperature range. More compute-intense operations may generate more heat, which may be beyond the capabilities of air only cooling systems. As a result, data centers may incorporate liquid cooling systems, which may include cooling at a rack-level or at a chip-level, among other options. However, because compute units are sensitive electronic devices, leak detection is used to ensure that leaks can be quickly identified and isolated to reduce damage to electronic components. Typical leak detectors may be positioned within a rack and detect leaks at some threshold that provides sufficient liquid to wet a detector (e.g., physical contact with the leak), by which time the leak may be so severe that several electronic components are damaged.

### BRIEF DESCRIPTION OF THE DRAWINGS

Various embodiments in accordance with the present disclosure will be described with reference to the drawings, in which:

FIG. 1 illustrates an example data center cooling system, according to at least one embodiment;

FIG. 2A illustrates an example data center cooling system, according to at least one embodiment;

FIG. 2B illustrates rack-level features associated with a data center cooling system, according to at least one embodiment;

FIG. 2C illustrates rack-level features associated with a data center cooling system, according to at least one embodiment;

FIG. 3A illustrates an example representation of one or more chemical sensors associated with areas of interest within an enclosure, according to at least one embodiment;

FIG. 3B illustrates an example representation of one or more multi-layered tubulars, according to at least one embodiment;

FIG. 3C illustrates an example representation of one or more multi-layered tubulars, according to at least one embodiment;

FIG. 3D illustrates an example representation of one or more multi-layered tubulars, according to at least one embodiment;

FIG. 3E illustrates an example representation of one or more multi-layered tubulars, according to at least one embodiment;

FIG. 4A illustrates an example of a system including a controller and a multi-layered tubular, according to at least one embodiment;

FIG. 4B illustrates an example of a system including a controller and a multi-layered tubular, according to at least one embodiment;

FIG. 4C illustrates an example of a system including a controller and one or more multi-layered tubulars, according to at least one embodiment;

FIG. 4D illustrates an example of a system including a controller and one or more multi-layered tubulars, according to at least one embodiment;

FIG. 5A illustrates a leak detection process, according to at least one embodiment;

FIG. 5B illustrates a leak detection process, according to at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates an example computing environment, according to at least one embodiment;

FIG. 9 illustrates a computer system, according to at least one embodiment; and

FIG. 10 illustrates a computing system, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various embodiments are directed toward one or more leak detection systems that may be used to detect small leaks before the leaks are large enough to be detected with existing leak sensors.

Systems and methods of the present disclosure address and overcome problems with existing leak detection systems that may have limited detection capabilities with respect to detecting fluid. One challenge with leak detection is detecting leaks quickly to enable rapid remediation before damage occurs to sensitive electronic components. The problems of slow detection may be exacerbated in dense racks where more electronic components are packed into smaller spaces, resulting in dripping liquid possibly spreading to other equipment, such as by the associated fans of the components. Leaks at fittings are common and understood, so most leak detection is centered on leaks that occur there or leaks that result in liquid dripping down onto a sensor. In these cases, much of the damage is already done by the time that the leak is detected. In conventional systems, the hoses are largely ignored, and it is assumed that a hose failure would be rare or caught during data center provisioning. In some cases, a leak of this kind may go undetected or may not be detected until significant damage has been done to the data center components. The present embodiments solve for this problem.

One or more embodiments may be directed toward a leak detection system that may be used with a data center and/or an environment, including one or more liquid cooling systems. The liquid cooling system may be integrated into a larger cooling system, such as a cooling system for a data center, or may be localized and may further be sealed or semi-sealed for a given rack or set of processing units. By way of example, an enclosure may have isolated cooling loops for different processing units. These cooling loops may include one or more multi-layered tubulars with one or more sensing layers may further be arranged at different locations to facilitate detection of a leak location.

Unlike traditional systems that primarily focus on detecting leaks at fittings or from dripping liquid, the present embodiments integrate (e.g., embedded) multiple sensing layers within a cooling fluid transport tubular. This multi-layered design allows for detection of leaks as they occur along the tubular before a leak has breached the outer containment layer, including those that may not initially manifest as visible drips and can be fixed before damage has been done. By generating electrical signals in response to fluid presence within the sensing layers, the system can identify leaks much earlier in their development, thereby enabling faster remediation actions before extensive damage occurs to sensitive electronic components.

Moreover, the use of non-contiguous sensing zones enhances flexibility in installation and deployment, allowing for customized configurations based on specific data center layouts and requirements. This adaptability ensures comprehensive coverage and monitoring of potential leak sources throughout the cooling infrastructure. In contrast to conventional methods that often overlook hose integrity, this solution proactively addresses vulnerabilities across all components of the cooling system, significantly reducing the risk of failures due to undetected leaks. Ultimately, the present embodiments not only improve operational safety but also contribute to overall efficiency by minimizing downtime and maintenance costs associated with water damage in critical data center environments.

The leak detection system may include a multi-layered cooling fluid transport tubular further, including a first annular layer, a first sensing layer (i.e., inner sensing layer), a dielectric layer, a second sensing layer (e.g., outer sensing layer), and a second annular layer. The first annular layer forms a flow bore within the tubular in which coolant or other liquid may flow through the tubular. In example embodiments, a leak may form in the first annular layer of the tubular. As a nonlimiting example, a defect or some damaging force may cause the first annular layer of the tubular to form a leak. The leak may travel through the first annular layer and into the first sensing layer, the dielectric layer, and the second annular layer. The two sensing layers may be continuous or discontinuous defining spaced apart sensing elements. The two sensing layers may be comprised of conductive materials such that when the leak forms in the first annular layer and/or between the first annular layer and the second annular layer, the sensing layers generate an electrical charge due to the presence of the liquid. This signal is sent to a controller, which may determine based on the signal that a leak has occurred and take responsive action. In other example embodiments, the first sensing layer, second sensing layer, and dielectric layer form a sensing zone. Along the length of the cooling fluid transport tubular, one or more sensing zones may be arranged. The sensing zones may be non-contiguous such that at least a portion of the tubular does not include a sensing zone. The plurality of the sensing zones enables to localize the region of the leak of the hose, being especially useful for long hose runs.

In some embodiments, the first annular layer may be configured to retain the liquid if the second annular layer is breached.

In other example embodiments, the sensing zones may include a third sensing layer positioned between the second sensing layer and the second annular layer, as well as a second dielectric layer between the third sensing layer and the second annular layer. In this example, a second signal is generated responsive to a second leak formed in the second annular layer as the leak migrates toward the third sensing layer. The sensing layers may be electrically coupled in order to produce the electrical signal in the presence of a leak.

The leak detection system may also include one or more processing units to determine, based on a signal transmitted from at least one or more sensing layers if there is a leak in one or more of the multi-layered tubulars. In at least one embodiment, the one or more liquids may be detected when a quantity of the one or more liquids come into contact with at least a portion of the one or more sensing layers, and the sensing layers responsively generate a signal. A controller or processor may receive this signal and determine a change in condition—i.e., a change in electrical charge—among the sensing layers. As a nonlimiting example, the controller may determine that the change in condition corresponds to a leak in the inner containment layer and generate an alert indicative of the leak. As another nonlimiting example, the controller may determine that the change in condition corresponds to a leak from the outer containment layer and generate an alert indicative of the leak.

Additionally, the leak detection system may be used to identify one or more leaks via a control system that monitors and/or interprets signals received from the one or more sensing layers. For example, the control system may identify one or more leaks associated with the one or more sensing layers based, at least in part, on a signal from at least one sensing layer of the multi-layered tubulars. The control system may be in communication with other controllers, central controllers, user devices, administrative devices, clouds, servers, or other devices.

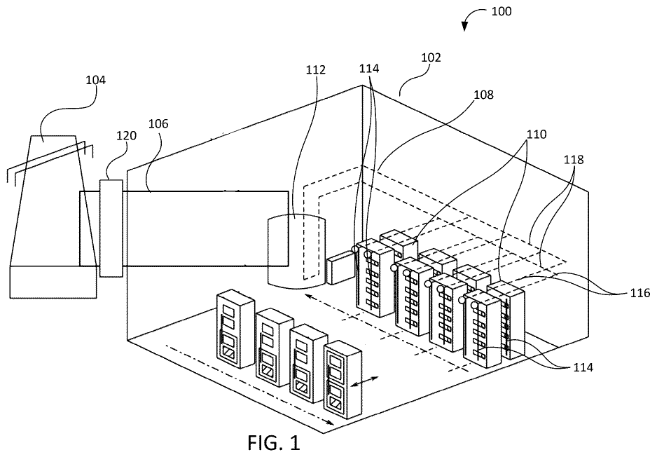

In at least one embodiment, a data center 100 can be utilized as illustrated in FIG. 1, which has a cooling system subject to improvements described herein. Although not show, the data center may be configured as a development server labs, mobile data centers, manufacturing data centers, in which higher risks of leaks can occur. Even in standard data centers this provides early leak detection. In at least one embodiment, a data center 100 may be one or more rooms 102 having racks 110 and auxiliary equipment to house one or more servers on one or more server trays. In at least one embodiment, a data center 100 is supported by a cooling tower 104 located external to a data center 100. In at least one embodiment, a cooling tower 104 dissipates heat from within a data center 100 by acting on a primary cooling loop 106. In at least one embodiment, a cooling distribution unit (CDU) 112 is used between a primary cooling loop 106 and a second or secondary cooling loop 108 to enable absorption of heat from a second or secondary cooling loop 108 to a primary cooling loop 106. Each of these cooling loops 106 and 108 may include one or more multi-layered tubulars or multi-layered hoses described herein. In at least one embodiment, cooling loops 106, 108 are illustrated as line drawings, but a person of ordinary skill would recognize that one or more plumbing features may be used. In at least one embodiment, flexible polyvinyl chloride (PVC) pipes may be used along with associated plumbing to move fluid along in each provided cooling loop 106, 108. In at least one embodiment, one or more coolant pumps may be used to maintain pressure differences within cooling loops 106, 108 to enable movement of coolant according to temperature sensors in various locations, including in a room, in one or more racks 110, and/or in server boxes or server trays within one or more racks 110.

In at least one embodiment, coolant in a primary cooling loop 106 and in a secondary cooling loop 108 may be at least water and an additive. In at least one embodiment, an additive may be glycol or propylene glycol. In operation, in at least one embodiment, each of a primary and a secondary cooling loops may have their own coolant. In at least one embodiment, coolant in secondary cooling loops may be proprietary to requirements of components in a server tray or in associated racks 110. In at least one embodiment, a CDU 112 is capable of sophisticated control of coolants, independently or concurrently, within provided cooling loops 106, 108. In at least one embodiment, a CDU may be adapted to control flow rate of coolant so that coolant is appropriately distributed to absorbed heat generated within associated racks 110. In at least one embodiment, more flexible tubing of row manifold 114 is provided from a secondary cooling loop 108 to enter each server tray to provide coolant to electrical and/or computing components therein.

In at least one embodiment, tubing of a row manifold 118 that forms part of a secondary cooling loop 108 may be referred to as room manifolds. Separately, in at least one embodiment, further tubing of a row manifold 116 may extend from the tubing of a row manifold 118 and may also be part of a secondary cooling loop 108 but may be referred to as row manifolds. In at least one embodiment, coolant tubing of a row manifold 114 enters racks as part of a secondary cooling loop 108 but may be referred to as rack cooling manifold within one or more racks. In at least one embodiment, row manifolds 116 extend to all racks along a row in a data center 100. In at least one embodiment, plumbing of a secondary cooling loop 108, including coolant row manifolds 118, 116, and 114 may be improved by at least one embodiment herein. In at least one embodiment, a chiller 120 may be provided in a primary cooling loop within data center 100 to support cooling before a cooling tower. In at least one embodiment, additional cooling loops that may exist in a primary control loop and that provide cooling external to a rack and external to a secondary cooling loop, may be taken together with a primary cooling loop and is distinct from a secondary cooling loop, for this disclosure.

In at least one embodiment, in operation, heat generated within server trays of provided racks 110 may be transferred to a coolant exiting one or more racks 110 via flexible tubing of a row manifold 114 of a secondary cooling loop 108. In at least one embodiment, second coolant (in a secondary cooling loop 108) from a CDU 112, for cooling provided racks 110, moves towards one or more racks 110 via provided tubing. In at least one embodiment, second coolant from a CDU 112 passes from one side of a room manifold having tubing of a row manifold 118, to one side of a rack 110 via a row manifold 116, and through one side of a server tray via different tubing of a row manifold 114. In at least one embodiment, spent or returned second coolant (or exiting second coolant carrying heat from computing components) exits out of another side of a server tray (such as enter left side of a rack and exit right side of a rack for a server tray after looping through a server tray or through components on a server tray). In at least one embodiment, spent second coolant that exits a server tray or a rack 110 comes out of different side (such as exiting side) of tubing of a row manifold 114 and moves to a parallel, but also exiting side of a row manifold 116. In at least one embodiment, from a row manifold 116, spent second coolant moves in a parallel portion of a room manifold of a row manifold 118 and is going in an opposite direction than incoming second coolant (which may also be renewed second coolant), and towards a CDU 112.

In at least one embodiment, spent second coolant exchanges its heat with a primary coolant in a primary cooling loop 106 via a CDU 112. In at least one embodiment, spent second coolant may be renewed (such as relatively cooled when compared to a temperature at a spent second coolant stage) and ready to be cycled back to through a secondary cooling loop 108 to one or more computing components. In at least one embodiment, various flow and temperature control features in a CDU 112 enable control of heat exchanged from spent second coolant or flow of second coolant in and out of a CDU 112. In at least one embodiment, a CDU 112 may be also able to control a flow of primary coolant in primary cooling loop 106.

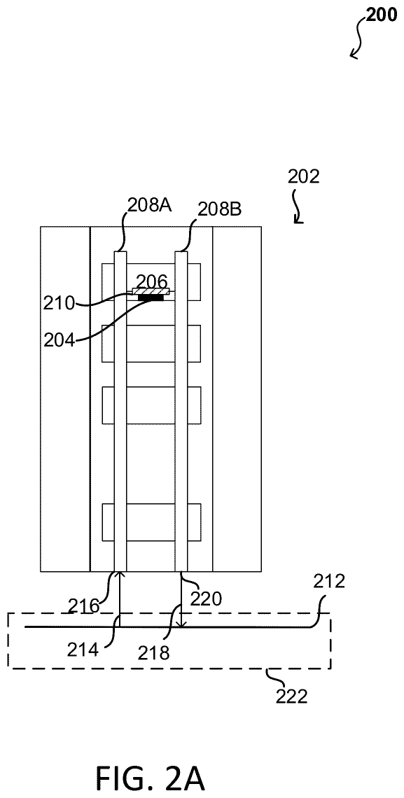

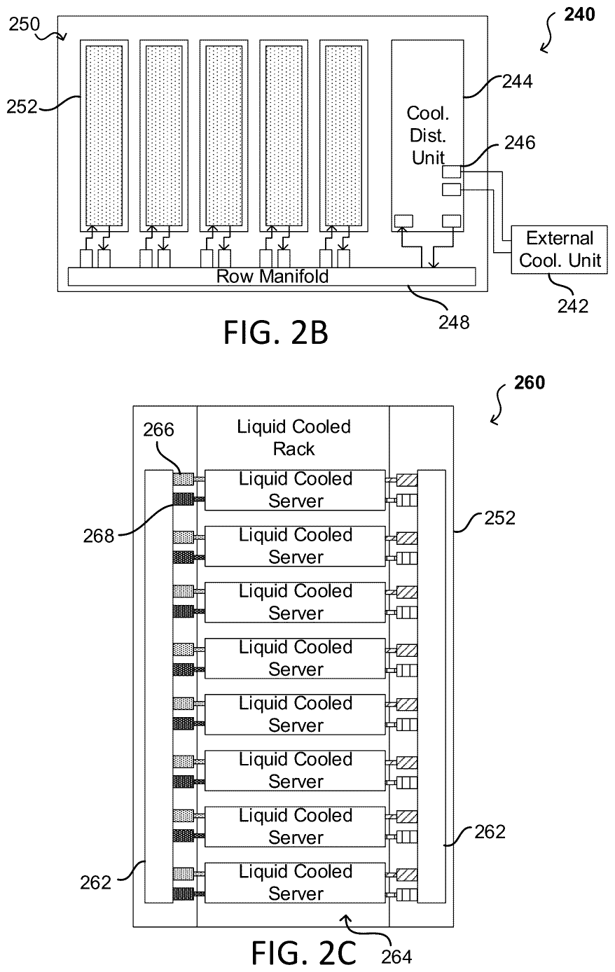

FIG. 2A illustrates an example environment 200 that may be used with embodiments of the present disclosure to provide cooling fluid through one or more multi-layered tubulars to one or more computing devices. In this example, a rack 202 is used to house a number of computing devices 204 (e.g., servers, processing units, etc.) in a stacked configuration. The configuration of FIG. 2A may be referred to as showing “rack-level features” for cooling one or more computing devices 204, but embodiments of the present disclosure are not limited to only rack-level cooling and may be expanded to other cooling configurations and arrangements.

The illustrated rack 202 includes a number of shelves 206 that may hold one or more computing devices 204. Each of these shelves 206, and/or the computing devices 204 associated with the shelves 206, may be associated with manifolds 208, which may include an inlet manifold 208A (e.g., a supply manifold) and an outlet manifold 208B (e.g., a return manifold), to provide a cooling fluid to dissipate heat away from the one or more computing devices 204 and then to carry heated fluid away from the one or more computing devices 204 via one or more multi-layered tubulars. In this example, the manifolds 208 may be coupled to one or more heat plates 210 associated with the one or more computing devices 204, for example via tubing or the like. As discussed herein, the tubing may include plastic tubing, metallic tubing, composite tubing, and/or combinations thereof.

The shelves 206 may also include a variety of different sensors, which may be mounted within the shelf. For example, fluid detectors, such as ribbon detectors, may be positioned within the shelves 206 to detect leaks associated with a cooling fluid system 222. However, these sensors often need a threshold amount of liquid prior to obtaining a signal indicative of a leak. Often, by the time the leak is detected, damage is significant and/or may lead to a sudden preventative action, instead of proactively identifying leaks and then scheduling maintenance. Embodiments of the present disclosure may address and overcome this problem may detecting leaks sooner and at smaller quantities of leaked fluid.

While the illustrated example includes a single inlet manifold 208A and a single outlet manifold 208B, various embodiments may include more manifolds 208 and the manifolds may be arranged at different locations. For example, the manifolds 208 may be arranged at sides of the rack 202 to provide improved access to the interior of the rack, such as the shelves 206. Additionally, in at least one embodiment, the manifolds 208A, 208B may be positioned on opposite sides of the rack 202. Furthermore, embodiments may include multiple manifolds 208, with particular manifolds being used to direct fluid to/from particular shelves 206. Accordingly, a variety of configurations for cooling manifolds may be used within the scope of the present disclosure.

The manifolds 208 are shown coupled to a row manifold 212, which may be part of a secondary cooling loop. The row manifold 212 may include both an “inlet” line that carries cool fluid toward the shelves 206 and an “outlet” line that carries heated fluid away from the shelves 206. The row manifold 212 may include a connection 214 to a source inlet 216 of the manifold 208A and a connection 218 to a source outlet 220. The source inlet 216 may carry the cooled fluid along a length of the manifold to one or more outlets that may direct the cooled fluid toward the heat plates 210. The heat plates 210 may then include different connections to inlets of the manifold 208B that may direct heated fluid to the source outlet 220 to return to the row manifold 212 so that heated fluid may be cooled and then reused. As discussed herein, the row manifold 212 may be part of one or more cooling fluid systems 222, which may include components discussed, for example, in FIG. 1.

FIG. 2B illustrates a system 240 that may be used with embodiments of the present disclosure. The illustrated system 240 may include various features discussed with reference to FIG. 2A and herein, such as external cooling unit 242, such as a cooling tower, which may be part of an overall data center cooling system. This example illustrates the external cooling unit 242 coupled to a cooling distribution unit 244, which may be for a data center as a whole, or in certain embodiments, may be a localized cooling distribution unit at a rack or row level, among other options. The illustrated cooling distribution unit 244 may include a control board 246 to receive data from a variety of sensors associated with the cooling system. For example, the one or more sensors may provide coolant flow rate data, cooling pressure data, status of auxiliary systems, and/or the like.

The illustrated embodiment includes a row manifold 248 that sends/receives cooling fluid to/from the cooling distribution unit 244. The row manifold 248 also distributes and receives cooling fluid from a row 250 of racks 252, which in this example are liquid cooled racks. In at least one embodiment, there can be different levels of flow into, and out of, different liquid cooled racks. Additionally, there may also be different flows into individual servers in a rack. As discussed herein, systems and methods of the present disclosure may be used to form one or more portions of the row manifold 248 and/or may be used as part of a rack-specific manifold, as discussed herein.

FIG. 2C illustrates a system 260 that may be used with embodiments of the present disclosure. This example system includes the rack 252 with rack-level manifolds 262. As shown, the rack 252 includes a number of liquid cooled servers 264 or other such devices. In at least one embodiment, the rack-level manifold 262 provides a flow of liquid into each liquid cooled server 264 through an inlet valve 266, and returns liquid with heat removed from that liquid cooled server 264 through an outlet valve 268. In at least one embodiment, sensors can capture information about temperature, fluid flow, or other such aspects of a computing environment internal and/or external to the rack 252, including internal and/or external to any individual liquid cooled servers 264 located therein. Fluid associated with the rack-level manifold 262 may be used to remove an amount of heat from liquid cooled servers 264, but due to factors such as varying load and external temperature fluctuations, temperatures at various locations may change, and may reach or exceed temperature limits at which these devices can continue to operate correctly. In at least one embodiment, an attempt can be made to ensure that temperatures at specific locations remain below an acceptable limit, where those locations may relate to junction temperatures or core temperatures for a processor (e.g., a central processing unit (CPU) or graphics processing unit (GPU)), data processing units (DPUs), quantum processing units (QPUs), a plurality of parallel processing units (PPUs), and application-specific integrated circuits (ASICs) memory module, or power supply. QPUs configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with.

In at least one embodiment, fluid quality is monitored and controlled at a rack-level using one or more assemblies or sensors, for example inline flow sensors that can be associated with the rack-level manifold 262 as a whole and/or for individual liquid cooled servers 264. Different racks and servers may have different flow characteristics, such as different diameter flow channels in direct-to-chip cooling boards, and as a result, different cooling configurations, different manifold sizes, and/or different manifold properties may be used.

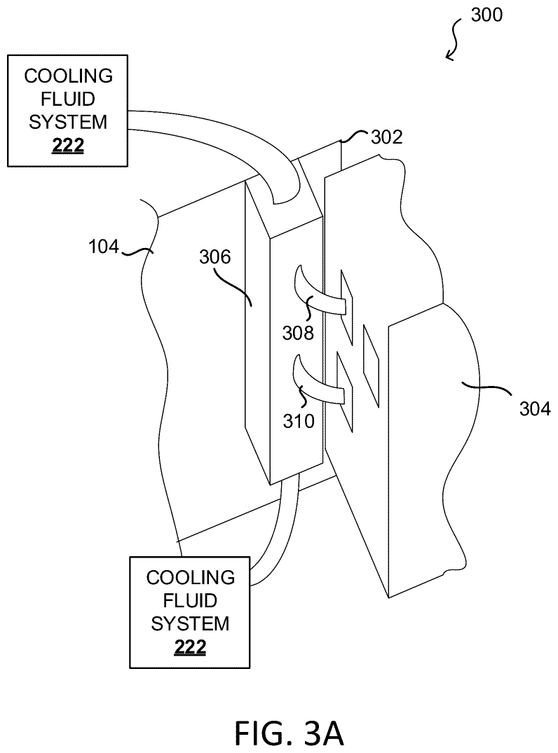

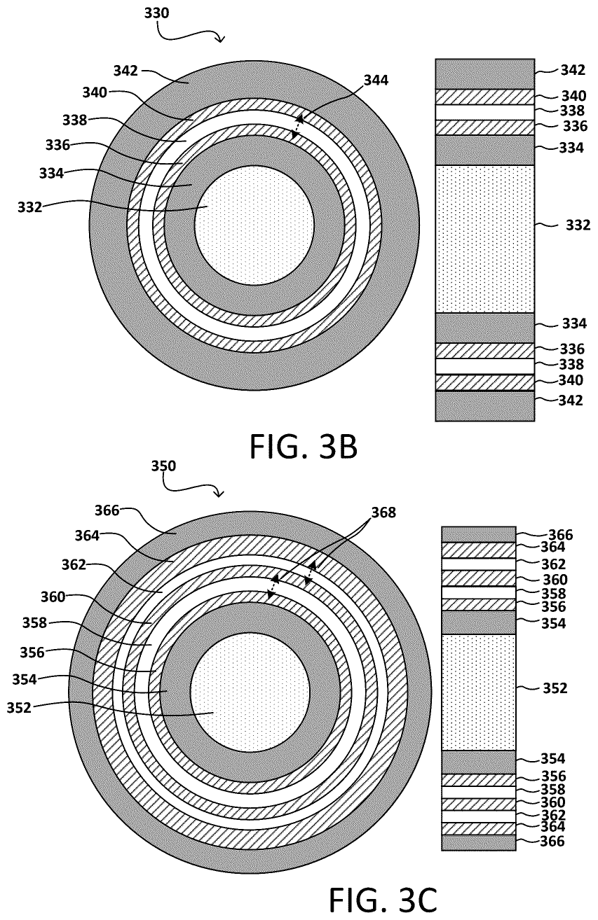

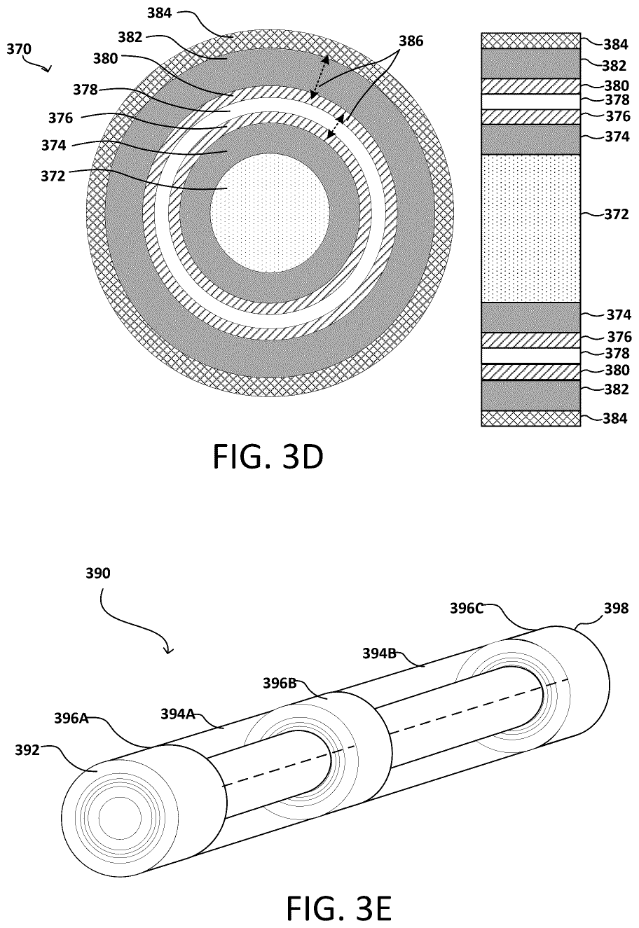

FIG. 3A illustrates a schematic representation of an environment 300 that may use embodiments of the present disclosure. In this example, an enclosure 302 includes an electronic component 304, such as a server unit, which may include a number of different electronic components and/or heat-generating units, as discussed herein. The enclosure 302 in this example is used for liquid cooling operations and includes a manifold 306 with inlet and outlet flow paths 308, 310 which may run through one or more multi-layered tubulars or multi-layered hoses. The illustrated manifold is part of the cooling fluid system 222, which may include one or more cooling loops. These cooling loops may include one or more multi-layered tubulars with one or more sensing layers may further be arranged at different locations to facilitate detection of a leak location. As discussed herein, the inlet and outlet flow paths 308, 310 may be coupled to the manifold 306 and/or the electronic component 304 at one or more connecting locations which may be more susceptible to leakage than other locations.

FIG. 3B illustrates an example schematic representation of a cooling fluid transport tubular 330 that may be used with embodiments of the present disclosure. This illustrated example includes components of the cooling fluid transport tubular 330 including a first layer 334 forming a flow bore through which cooling liquid 332 may flow, a first sensing layer 336, a dielectric layer 338, a second sensing layer 340, and a second layer 342. Each layer may be positioned radially outward from and coaxial with the preceding layer. In at least one embodiment, the first sensing layer 336 is positioned radially outward from and coaxial with the first layer 334; the dielectric layer 338 is positioned radially outward from and coaxial with the first sensing layer 336; the second sensing layer 340 is positioned radially outward from and coaxial with the dielectric layer 338; and the second layer 342 is positioned radially outward from and coaxial with the second sensing layer 340. In example embodiments, the first sensing layer 336, dielectric layer 338, and second sensing layer 340 form a sensing stack or sensing layer. The cooling liquid 332 generally includes water, water solutions (e.g., propylene glycol-water), brine, antifreeze, a mixture of antifreeze and water, oil, alcohol, mercury or the like or any other suitable heat conductive fluid. The heat transfer fluid may be an electrically conductive cooling liquid and may include water, deionized water, or a coolant such as R-134a, a mixture of water and additives, such as a mixture of water and ethylene glycol or a mixture of water and propylene glycol e.g., a 25% concentration of propylene glycol in deionized water. The heat transfer fluid may also be a dielectric fluid alone (e.g., not having water for purposes of this disclosure) or a water in combination with an additive including at least one dielectric fluid, such as or one or more of de-ionized water, ethylene glycol, and propylene glycol. In at least one embodiment, the heat transfer fluid may be an absorption chiller having a working fluid being a mixed solution containing lithium bromide as the absorbent material and water as the carrier material. The heat transfer fluid may also be a two-phase coolant that has a boiling point that is below the expected operating temperature of the electronic devices. Exemplary two-phase coolants include 2, 3, 3, 3-tetrafluoropropene, 1, 1, 1, 2-tetrafluoroethane and water.

In some example embodiments, the sensing stack may have a shorter or longer diameter or length than either or both of the first annular layer 334 and the second annular layer 342. In at least one embodiment, the radial thickness of the first annular layer 334 may be less than, equal to, or greater than the radial thickness of the second annular layer 342. The thickness of each layer can vary, and the thicknesses of the layers illustrated in FIG. 3B should not be seen as limiting.

In at least one embodiment, the first sensing layer 336 and the second sensing layer 340 are made of conductive materials, including without limitation metal, polymers, graphene, or any other suitably conductive material. In at least one embodiment, the dielectric layer 338 can also be made of conductive materials as described herein as well as plastic. In other example embodiments, the dielectric layer 338 may be an empty pocket of air between the first sensing layer 336 and second sensing layer 340. In other example embodiments, the dielectric layer 338 may be a water permeable layer, i.e., the dielectric layer 338 allows coolant or other liquid to pass through either the first sensing layer 336 to the second sensing layer 340 or from the second sensing layer 340 to the first sensing layer 336. In other embodiments, the dielectric layer 338 may be a water soluble layer, meaning that any coolant or other liquid that passes through either or both the first sensing layer 336 and second sensing layer 340 into the dielectric layer 338 can partially or completely dissolve a portion of the dielectric layer 338.

In at least one embodiment, the multi-layered hose 350 may include an electrical coupling 344 that connects the first sensing layer 336 and the second sensing layer 340. The electrical coupling 344 can include without limitation a capacitive coupling in which the first sensing layer 336 and the second sensing layer 340 act as plates of a capacitor. In some embodiments, the presence of a leak between the first sensing layer 336 and the second sensing layer 340 will cause a change in capacitance and can be detected by a controller, processor, or module monitoring changes in voltage across the first sensing layer 336 and the second sensing layer 340.

In other example embodiments, the electrical coupling 344 may include a resistive coupling in which the resistance measurements between the first sensing layer 336 and the second sensing layer 340 are used to detect leaks. In some embodiments, when there is no presence of a leak, the electrical coupling 344 would have a baseline resistance value. However, if there is a presence of a leak, the coolant or liquid may alter resistance and thereby indicate a leak to the one or more controllers.

In other example embodiments, the dielectric layer 338 can be composed of one or more fibrous materials, such as polyester, nylon, natural fibers like cotton, or some combination thereof. In such example embodiments, when a coolant or liquid breaches a sensing layer barrier and permeates into the dielectric layer 338, the fibrous structure of the dielectric layer 338 may disperse the liquid throughout the sensing layers. This increased distribution may enhance the likelihood that the sensing layers will detect the presence of a leak. The capillary action of the fibers may allow for quicker absorption and movement of the liquid, amplifying the sensitivity of the sensing layers to moisture.

FIG. 3C illustrates an example schematic representation of a multi-layered hose 350 that may be used with embodiments of the present disclosure. The multi-layered hose 350 may also be referred to as a cooling fluid transport tubular or a multi-layered tubular.

This illustrated example includes components of the multi-layered hose 350 including a first annular layer 354 forming a flow bore through which coolant 352 may flow, a first sensing layer 356, a first dielectric layer 358, a second sensing layer 360, a second dielectric layer 362, a third sensing layer 364, and a second annular layer 366. Each layer may be positioned radially outward from and coaxial with the preceding layer.

In at least one embodiment, the first sensing layer 356 is positioned radially outward from and coaxial with the first annular layer 354; the first dielectric layer 358 is positioned radially outward from and coaxial with the first sensing layer 356; the second sensing layer 360 is positioned radially outward from and coaxial with the first dielectric layer 358; the second dielectric layer 362 is positioned radially outward from an coaxial with the second sensing layer 360; the third sensing layer 364 is positioned radially outward from and coaxial with the second dielectric layer 362; and the second annular layer 366 is positioned radially outward from and coaxial with the third sensing layer 364.

In at least one embodiment, each layer has an inner diameter and an outer diameter. In at least one embodiment, the radial thickness of the first annular layer 354 may be less than, equal to, or greater than the radial thickness of the second annular layer 366. The thickness of each layer can vary, and the thicknesses of the layers illustrated in FIG. 3C should not be seen as limiting.

In at least one embodiment, the first sensing layer 356, the second sensing layer 360, and the third sensing layer 364 are made of conductive materials, including without limitation metal, polymers, graphene, or any other suitably conductive material. In at least one embodiment, the first dielectric layer 358 and second dielectric layer 362 can also be made of conductive materials as described herein, as well as plastic. In other embodiments, the first dielectric layer 358 and second dielectric layer 362 can both be an empty pocket of air between the first sensing layer 356 and second sensing layer 360 and between the second sensing layer 360 and the third sensing layer 364, respectively. In at least one embodiment, the first dielectric layer 358 and second dielectric layer 362 may be water permeable meaning that the first dielectric layer 358 and second dielectric layer 362 allow coolant or other liquid to pass through from either the first sensing layer 356 to the second sensing layer 360 or from the second sensing layer 360 to the first sensing layer 336; or either from the second sensing layer 360 to the third sensing layer 364 or from the third sensing layer 364 to the second sensing layer 360. In other embodiments, the first dielectric layer 358 and second dielectric layer 362 may be water soluble, meaning that any coolant or other liquid that passes through either dielectric layer can partially or completely dissolve a portion of the first dielectric layer 358 and second dielectric layer 362.

In other embodiments, the first dielectric layer 358 and second dielectric layer 362 can be composed of one or more fibrous materials, such as polyester, nylon, natural fibers like cotton, or some combination thereof. When a coolant or liquid breaches a sensing layer barrier and permeates into the first dielectric layer 358 and second dielectric layer 362, the fibrous structure of the first dielectric layer 358 and second dielectric layer 362 may disperse the liquid throughout the sensing layers. This increased distribution enhances the likelihood that both sensing layers will detect the presence of a leak. The capillary action of the fibers allows for quicker absorption and movement of the liquid, amplifying sensitivity to moisture.

In at least one embodiment, the multi-layered hose 350 may include one or more electrical couplings 368 that connects the first sensing layer 356 to the second sensing layer 360, and the second sensing layer 360 to the third sensing layer 364. The electrical coupling 368 can include without limitation a capacitive coupling in which the pair of the first sensing layer 356 and the second sensing layer 360 and the pair of the second sensing layer 360 and the third sensing layer 364 act as plates of a capacitor. In some embodiments, the presence of the leak between the first sensing layer 356 and the second sensing layer 360 or between the second sensing layer 360 and the third sensing layer 364 will cause a change in capacitance and can be detected by monitoring changes in voltage across the sensing layers.

In other example embodiments, the electrical coupling 368 may include a resistive coupling in which the resistance measurements between the first sensing layer 356 and the second sensing layer 360 and between the second sensing layer 360 and the third sensing layer 364 are used to detect leaks. In some embodiments, when there is no presence of a leak, the electrical coupling 368 would have a certain resistance value. However, if there is a presence of a leak, the electrical coupling 368 would have a different resistance value compared to there being no leak and thereby indicate a leak to the one or more controller.

FIG. 3D illustrates an example schematic representation of a multi-layered hose 370 that may be used with embodiments of the present disclosure. The multi-layered hose 370 may also be referred to as, without limitation, a tubular, multi-layered tubular, and cooling fluid hose. This illustrated example includes components of a multi-layered hose 370 including a first annular layer 374 forming a flow bore through with coolant 372 may flow, a first sensing layer 376, a dielectric layer 378, a second sensing layer 380, a second annular layer 382, and a third sensing layer 384. Each layer may be positioned radially outward from and coaxial with the preceding layer.

In at least one embodiment, each layer has an inner diameter and an outer diameter. In at least one embodiment, the radial thickness of the first annular layer 374 may be less than, equal to, or greater than the radial thickness of the second annular layer 382. The thickness of each layer can vary, and the thicknesses of the layers illustrated in FIG. 3D should not be seen as limiting.

In at least one embodiment, the multi-layered hose 370 may include one or more electrical couplings 386 that connects the first sensing layer 376 to the second sensing layer 380, and the second sensing layer 380 to the third sensing layer 384. The electrical coupling 386 can include without limitation a capacitive coupling in which the pair of the first sensing layer 376 and the second sensing layer 380 and the pair of the second sensing layer 380 and the third sensing layer 384 act as plates of a capacitor. In some embodiments, the presence of the leak between the first sensing layer 376 and the second sensing layer 380 or between the second sensing layer 380 and the third sensing layer 384 will cause a change in capacitance and can be detected by monitoring changes in voltage across the sensing layers.

In other example embodiments, the electrical coupling 386 may include a resistive coupling in which the resistance measurements between the first sensing layer 376 and the second sensing layer 380 and between the second sensing layer 380 and the third sensing layer 384 are used to detect leaks. In some embodiments, when there is no presence of a leak, the electrical coupling 386 would have a certain resistance value. However, if there is a presence of a leak, the electrical coupling 386 would have a different resistance value compared to there being no leak and thereby indicate a leak to the one or more controllers.

The third sensing layer 384 may be comprised of conductive materials described herein such as metals, graphene, or plastic. In example embodiments, the third sensing layer 384 may be comprised of different materials than the first sensing layer 376 and the second sensing layer 380, such as a metal braid, metal mesh, metal film, or some other material. In an example embodiment, the third sensing layer 384 may detect a change in electrical charge due to the presence of a leak, liquid, or puncture to the multi-layered tubular. If the third sensing layer 384 generates an electrical charge indicative of a leak, a controller may determine whether the leak from outside of the second annular layer 382 or from within the first annular layer 374.

FIG. 3E illustrates an example schematic representation of a multi-layered hose 390 that may be used with embodiments of the present disclosure. This illustrated example includes components of a multi-layered hose 390 of a length extending from a first connection 392 to a second connection 398. The first connection 392 and second connection 398 may connect with one or more connecting points associated with without limitation one or more cooling manifolds in a data center as described herein. Although FIG. 3E illustrates the multi-layered 390 as a certain length and shape, in other embodiments the multi-layered hose 390 may include any length, shape, or flexibility according to various applications.

The length of the multi-layered hose 390 may include one or more sensing stacks 396A, 396B, and 396C comprising the sensing layers illustrated with further reference to FIGS. 3A, 3B, 3C, and 3D. The sensing stacks 396A, 396B, and 396C may be spaced non-contiguously along the multi-layered hose 390. In some embodiments, the sensing stacks 396A, 396B, and 396C may be of any suitable length. Even though FIG. 3E illustrates only three sensing zones, it is understood that any suitable number of sensing stacks may be included in the multi-layered hose 390. In some embodiments, the multi-layered hose 390 may include one or more sensing stacks and one or more portions of the multi-layered hose 390 that do not include sensing stacks. In other words, the multi-layered hose 390 may include one or more sensing stacks 396 with one or more empty portions 394A and 394B that do not include any sensing stacks. As illustrated in FIG. 3E, two empty portions 394A and 394B sit between three sensing stacks 396A, 396B, and 396C. The number and length of the empty portion and sensing zones can vary beyond what is illustrated in FIG. 3E.

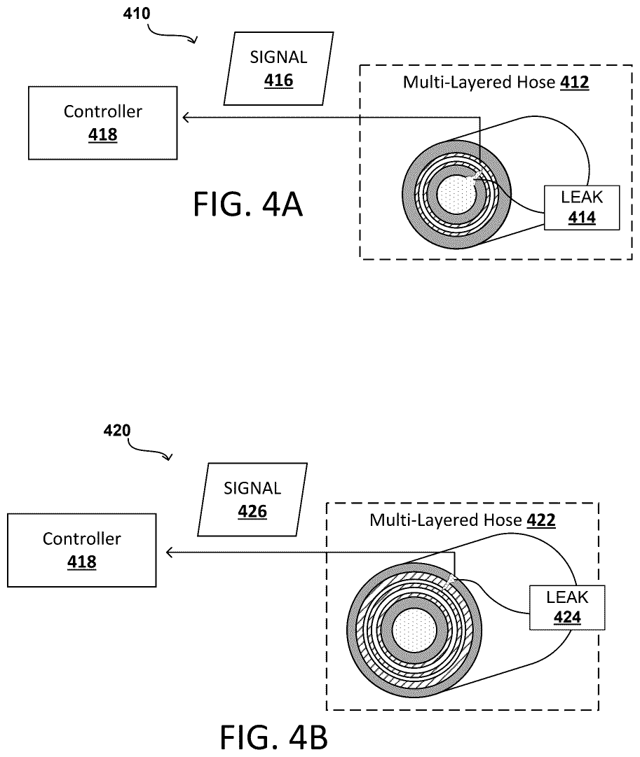

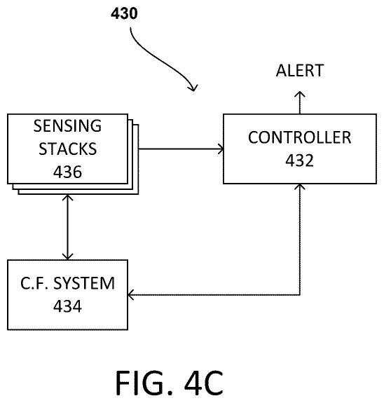

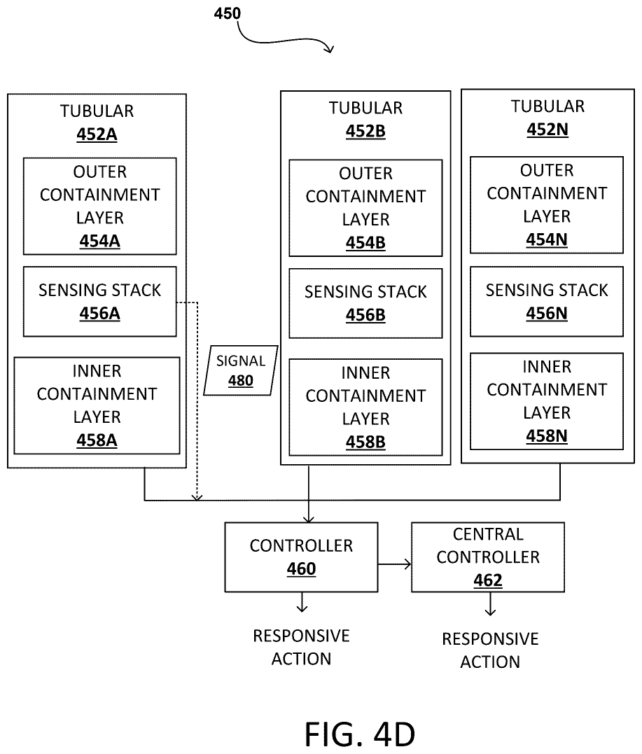

FIG. 4A illustrates an example schematic representation 410 that may be used with embodiments of the present disclosure. A multi-layered hose 412 includes a sensing layer or sensing stack capable of producing a signal or electrical charge responsive to the presence of liquid such as coolant. A leak 414 forms in the multi-layered hose 412. The leak 414 forms from within the multi-layered hose 412 and spreads from the first annular layer of the multi-layered hose 412 to one or more of the first sensing layer, dielectric layer, and second sensing layer of the sensing stack. When the leak 414 enters the sensing stack, the stack generates an electrical signal 416 which is transmitted to a controller 418. The electrical signal 416 may include a change in condition such as a change in conductivity, resistance, and/or capacitance due to the presence of liquid. In example embodiments, the electrical signal is generated responsive to a leak formed in the first annular layer as the leak migrates through the sensing stack toward the second annular layer. The controller 418 may receive the electrical signal 416 over a wired or wireless connection from the multi-layered hose 412. It is understood that other embodiments may include more sensing layers and dielectric layers, and that leaks may come from within the first annular layer or from outside the second annular layer.

FIG. 4B illustrates an example schematic representation of a multi-layered hose 420 that may be used with embodiments of the present disclosure. A leak 424 forms in the multi-layered hose 422 from the outermost annular layer of the multi-layered hose 422, in this case, the second annular layer, and spreads to the one or more inner layers of the multi-layered hose 412 including one or more sensing layers and dielectric layers within the multi-layered hose 422. When the leak 424 enters one or more of the sensing layers or dielectric layers, the one or more sensing layers produce an electrical signal 426 which is sent to the controller 418. The electrical signal 426 may include a change in condition such as a change in conductivity, resistance, and/or capacitance due to the presence of liquid. In example embodiments, an electrical signal is generated responsive to a leak formed in the second annular layer as the leak migrates toward the first annular layer. The controller 418 may receive the electrical signal 416 over a wired or wireless connection from the multi-layered hose 412. It is understood that other embodiments may include more sensing layers and dielectric layers, and that leaks may come from within the first annular layer or from outside the second annular layer.

FIG. 4C illustrates an example schematic representation of a leak detection system 430 that may be used with embodiments of the present disclosure. One or more embodiments may use a controller 432, which may be a central controller associated with an overall data center cooling fluid system 434 and/or a controller particularly associated with the leak detection system 430, to monitor one or more sensing stacks 436 within one or more multi-layered hoses or multi-layered tubulars. The cooling fluid system 434 may include one or more multi-layered tubulars including the one or more sensing stacks 436. The one or more sensing stacks 436 may encounter leaks within the tubulars, the leaks including without limitation liquids such as water, coolant, additives, or any combination thereof.

The controller 432 may generate one or more alerts responsive to the electrical signal from the sensing stacks 436. In example embodiments, one or more sensing stacks 436 may encounter a liquid which causes the sensing stacks 436 to communicate the presence of a leak to the controller. In example embodiments, the sensing stacks 536 may produce an electrical charge caused by the presence of the liquid. The controller 432 receives electrical charge and determines the presence of a leak in the multi-layered tubular associated with the sensing stacks 436. Upon determining that a leak is present, the controller 432 may generate an alert indicating the presence of a leak. The controller 432 may transmit this alert without limitation to other controllers, a user device, an administrative device, or other suitable device over a wired or wireless network. In some embodiments, the controller 432 may also generate an instruction or command to initiate a responsive action to the presence of the leak. In example embodiments, upon detecting a leak, the controller 432 may generate a task to inspect a rack region location for a leak in the multi-layered tubular. In example embodiments, the controller 432 may determine the source of the leak down to a specific sensing stack 436 on a multi-layered tubular as illustrated without limitation in FIG. 3E. In other example embodiments, the controller 432 may receive a leak indication corresponding to containment of the leak within the outer containment layer of a multi-layered tubular, then generate a task to replace at least a portion of the multi-layered tubular during a maintenance window.

In at least one embodiment, the controller 432 may further include one or more communication devices, such as a wired or wireless transceiver (e.g., a Bluetooth transceiver) that may use one or more low-power protocols to transmit signals to one or more central controllers. As discussed herein, the controller 432 and/or the wireless transceiver may be selectively disabled and/or deactivated after installation of the associated electronic components to maintain data center security requirements. In at least one embodiment, the controller 432 may not include any logic to evaluate the sensor information and may be used to pass through signals.

FIG. 4D illustrates an example schematic representation 450 that may be used with embodiments of the present disclosure. This illustrated example includes components of one or more multi-layered tubulars 452A, 452B, and 452N. Tubular 452A includes an outer containment layer 454A, a sensing stack 456A, and an inner containment layer 458A. Tubular 452B includes an outer containment layer 454B, a sensing stack 456B, and an inner containment layer 458B. Tubular 452N includes outer containment layer 454N, a sensing stack 456N, and an inner containment layer 458N. In example embodiments, each of the inner containment layers may be first annular layers that form a bore in the tubulars through which coolant or liquid may flow. Each of the sensing stacks may include one or more sensing layers comprising conductive materials that produce a change in electrical charge when the sensing layers encounter liquids. Each of the outer containment layers may be, without limitation, an outer annular layer that serves as the outmost exterior of the multi-layered tubulars.

Each of the multi-layered tubulars 452A, 452B, and 452N may connect via a wired or wireless connection or some combination therein with the controller 460. The controller 460 may be connected to a central controller 462 which may connect to one or more other controllers not shown in FIG. 4D.

In example embodiments, multi-layered tubular 452A may experience a leak. In some embodiments, a leak may form from within the inner containment layer 458A and flow into the sensing stack 456A and potentially past the outer containment layer 454A as well. In other example embodiments, the leak may form from outside of the outer containment layer 454A and flow into the sensing stack 456A and potentially past the inner containment layer 458A. In either event, the sensing stack 456A comes into contact with a leak such as coolant, moisture, or some other liquid. Upon coming into contact with the leak, the sensing stack 456A generates an electrical signal 480 including, in some example embodiments, an electrical charge from the change in condition such as a change in conductivity, resistance, or capacitance. The sensing stack 456A transmits the electrical signal 480 to the controller 460.

Upon receiving the electrical signal 480, the controller 460 may initiate a responsive action. In example embodiments, the responsive action can include a message or other indication that a leak has been detected. In some embodiments, the controller 460 may also generate an instruction or command to initiate a responsive action to the presence of the leak. As a nonlimiting example, upon detecting a leak, the controller 460 may generate a task to inspect a rack region location for a leak in the multi-layered tubular. In some example embodiments, the controller 460 may determine the source of the leak down to a specific sensing stack on a specific tubular. In other example embodiments, the controller 460 may receive a leak indication corresponding to containment of the leak within the outer containment layer of a multi-layered tubular, then generate a task to replace at least a portion of the multi-layered tubular during a maintenance window. The controller 460 may also transmit an indication of a leak (such as the electrical signal 480 itself or a generated notification of the presence of a leak) to the central controller 462 which may initiate a responsive action.

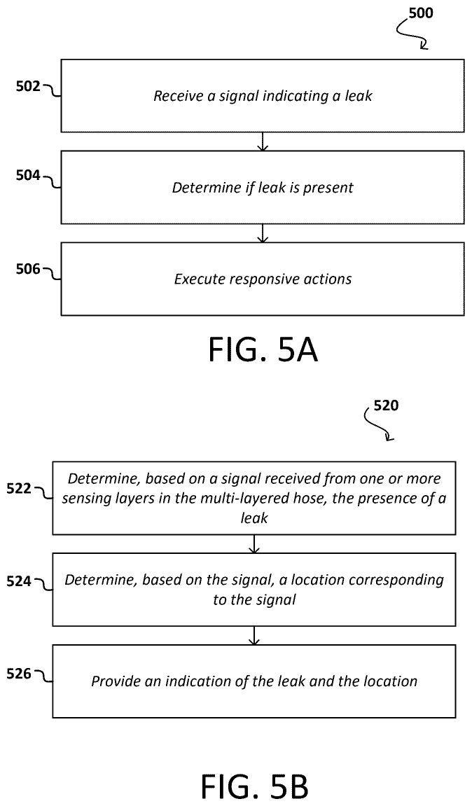

FIG. 5A illustrates an example process 500 for detecting a leak in a multi-layered hose. Each action in the process 500 can be performed by a controller, central controller, processor, or software module. It should be appreciated that steps for the method may be performed in any order, or in parallel, unless otherwise specifically stated. Moreover, the method may include more or fewer steps. The controller receives an electrical signal indicating a leak in one or more sections of one or more multi-layered hoses 502. In example embodiments, the controller may be electrically connected to the multi-layered hoses including one or more sensing layers. When the sensing layers encounter liquids such as coolant or moisture, the sensing layers generate an electrical signal which is received by the controller. The controller may receive one or more of these electrical signals one or more times, including continuously if a leak persists. The controller may determine if a leak is present 504. In example embodiments, the leak has reached a threshold before proceeding with a responsive action. In example embodiments, the controller may determine if the leak has persisted for a threshold amount of time, or if the electrical signal indicates that the leak is beyond a threshold size or quantity of liquid. Furthermore, the controller may determine that the leak is coming from inside the multi-layered hose or outside the multi-layered hose based on the electrical signals received, e.g., whether the electrical signal was received from a first and second sensing layer or a second and third sensing layer. Upon determining that a leak is present and/or that a leak has reached a predetermined threshold, the controller may execute one or more responsive actions 506. In example embodiments, the responsive action can include a message or other indication that a leak has been detected. The controller can send the message or indication to a user device, administrative device, central controller, or any device over a wired or wireless network. In other example embodiments, the controller may receive a leak indication corresponding to containment of the leak within the outer containment layer of a multi-layered tubular, then generate a task to replace at least a portion of the multi-layered tubular during a maintenance window. In still other example embodiments, the controller may receive a leak indication corresponding to location of the leak within an inner containment layer of a multi-layered tubular, then generate a task to replace at least a portion of the multi-layered tubular during a maintenance window.

FIG. 5B illustrates an example process 520 for detecting a leak in a multi-layered hose. It should be appreciated that steps for the method may be performed in any order, or in parallel, unless otherwise specifically stated. Each action in the process 520 can be performed by a controller, central controller, processor, or module. Moreover, the method may include more or fewer steps. A controller may determine, based on an electrical signal received from one or more sensing layers in the multi-layered hose, the presence of a leak 522. In example embodiments, the controller may be electrically connected to the multi-layered hoses which include one or more sensing layers. The electrical signal may include a difference or change in condition from the sensing layers of the hose, e.g., a difference in electrical charge due to the presence of a liquid. The controller may also determine if the leak has reached a threshold before proceeding with a responsive action. In example embodiments, the controller may determine if the leak has persisted for a threshold amount of time, or if the electrical signal indicates that the leak is beyond a threshold size or quantity of liquid. The controller may determine, based on the received electrical signal, a location corresponding to the electrical signal 524. In example embodiments, the controller may determine that the leak corresponds to a specific tubular in an area of the data center based on the electrical signal coming from a specific tubular or manifold of tubulars. In other example embodiments, the controller may determine that a certain section or sensing layer within a tubular is the location of the leak. In example embodiments, the controller may determine based on the electrical signal that the leak is coming from the first layer or inner layer, i.e., that the leak is coming from inside the multi-layered tubular. In other example embodiments, the controller may determine based on the electrical signal that the leak is coming from outer annular layer, i.e., that the leak is coming from outside of the house. The controller may provide an indication of the location of the leak 526. In example embodiments, the responsive action can include a message or other notification that a leak has been detected and that the leak is present in the inner layer, outer layer, or both. In other example embodiments, the controller may receive a leak indication corresponding to containment of the leak within the outer containment layer of a multi-layered tubular, then generate a task to replace at least a portion of the multi-layered tubular during a maintenance window. The controller can send the message, indication, or task to a user device, administrative device, central controller, or any device over a wired or wireless network.

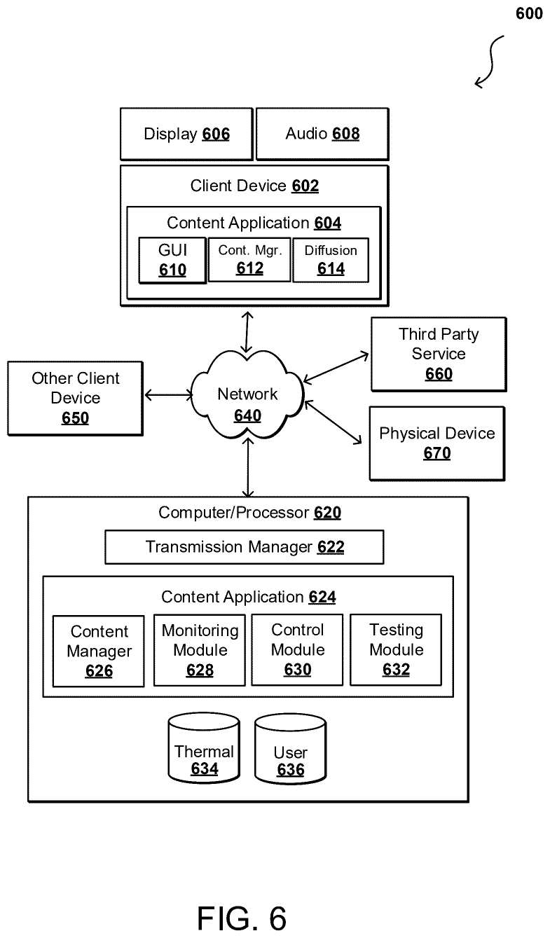

FIG. 6 illustrates an example network configuration 600 of components that can be used to implement aspects of various embodiments, such as to provide, generate, modify, encode, process, fuse, and/or transmit generated image data, calculated measurements, or other such content. In at least one embodiment, a client device 602 can generate or receive data for a session using components of a content application 604 on the client device 602 and data stored locally on that client device. In at least one embodiment, a content application 624 executing on a computer or processor 620 (e.g., a cloud server or control system) may initiate a session associated with at least one client device 602 (e.g., a vehicle or robot), as may use a session manager and user data stored in a user database 636, and can cause content such as liquid coolant or server thermal data to be selected and/or retrieved from a repository 634 to be used by a testing module 632 to calculate one or more performance metrics for a monitoring module 628, which can provide flow data or thermal data to a control module 630 to control a flow or temperature, in an environment where the data is to be used to determine appropriate operation. A content manager 626 may work with at least these various modules to perform testing and analysis, and potentially instruct any actions to be taken in response to a performance metric failing to satisfy an operational requirements. At least a portion of this data or instructional content can be transmitted to the client device 602 and/or a physical device 670 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, a flow monitor module 612, and a control module 614 for use in providing, synthesizing, rendering, compositing, modifying, or using content for presentation, navigation, control, (or other purposes) on or by the client device 602, such as may be transmitted to the physical device 670. In some embodiments, the computer or processor 620 and client device 602 may be able to communicate directly without needing to transmit data over a network 640, in order to avoid issues with latency and availability, etc. A decoder may also be used to decode data received over the network 640 for presentation via client device 602, such as imaging content or performance metrics through a display device 606 and audio, such as corresponding sounds or synthesized speech, through at least one audio playback device 608, such as speakers or headphones. In at least one embodiment, at least some of this content may already be stored on, rendered on, or accessible to client device 602 such that transmission over a network 640 is not required for at least that portion of content, such as where that content (e.g., thermal data) may have been previously downloaded or stored locally on a hard drive or optical disk. In at least one embodiment, a transmission mechanism such as data streaming can be used to transfer this content from the computer or processor 620, or user database 636, to the client device 602. In at least one embodiment, at least a portion of this content can be obtained, enhanced, and/or streamed from another source, such as a third party service 660 or other client device 650, that may also include a content application for generating, updating, enhancing, or providing map content. In at least one embodiment, portions of this functionality can be performed using multiple computing devices, or multiple processors within one or more computing devices, such as may include a combination of CPUs and GPUs (Graphics Processing Unit), (DPUs), (QPUs), a plurality of parallel processing units (PPUs).

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, which sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

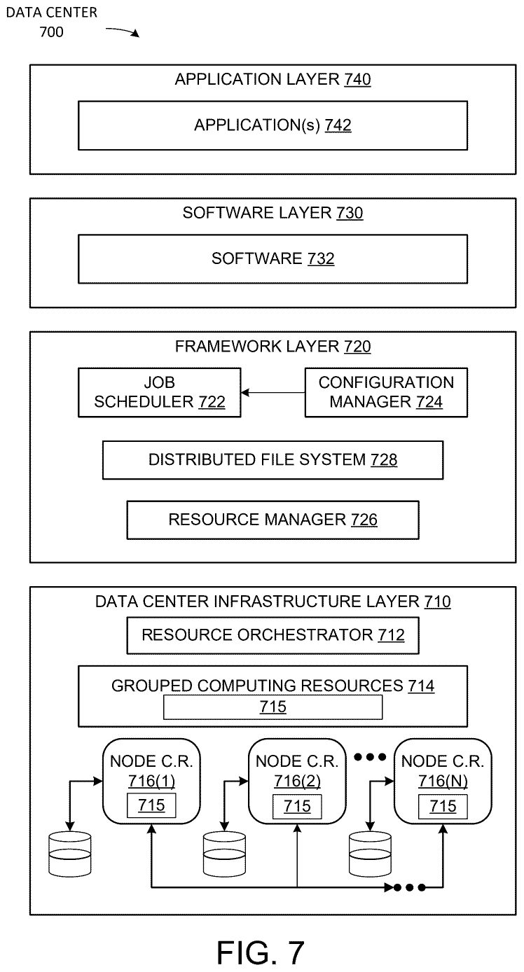

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, DPUs, QPUs, a plurality of parallel processing units (PPUs), or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used in data centers that use liquid cooling systems.

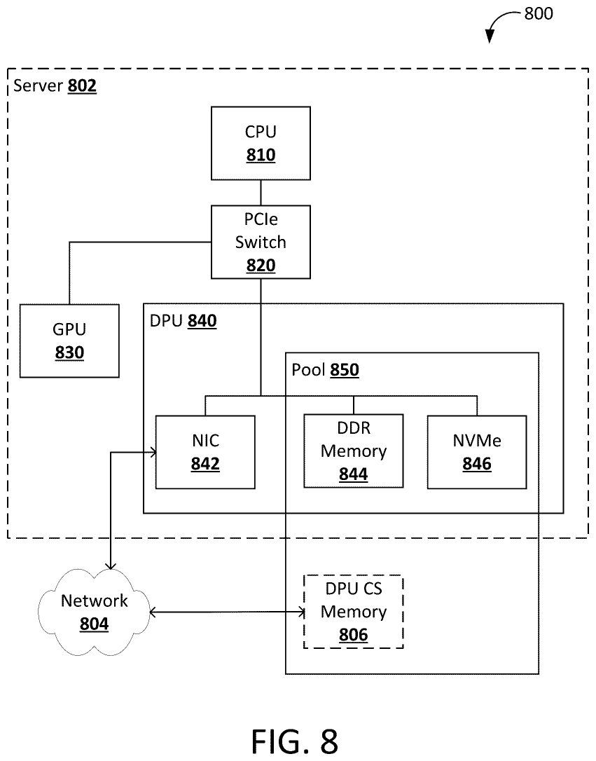

FIG. 8 illustrates an example computing environment 800 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 800 may include a server 802 which may be used to perform HPC workloads, such as AI training or machine learning model training. In an embodiment, the server 802 may be an application instance or a compute node. The server 802 may include a CPU 810 associated with a switch 820, such as a peripheral component interconnect express (PCIe) switch, which may control at least some data transmission over communication paths interconnecting various components. In an embodiment, the CPU 810 may include a root complex processor.

The PCIe switch 820 may also be associated with a GPU 830 and a DPU 840, and may transmit data between at least some of the CPU 810, the GPU 830, the DPU 840, and other components. In an embodiment, the PCIe switch 820 may be associated with more than one GPU or more than one DPU. In another embodiment, the PCIe switch 820 may be located within the DPU 840. The PCIe switch 820 may manage the transfer of at least some data between the CPU 810, the GPU 830, and the DPU 840. In another embodiment, the number of GPUs associated with the PCIe switch 820 may be equal to the number of DPUs associated with the PCIe switch 820. In at least one embodiment, the server 802 may include, without limitation, any number of the CPUs 810, the PCIe switches 820, the GPUs 830, and/or the DPUs 840, in any combination. For example, in at least one embodiment, server 802 could include eight, sixteen, thirty-two, and/or more GPUs 830. In at least one embodiment, communication paths interconnecting various components, including but not limited to the CPU 810, the PCIe switch 820, the GPU 830, and the DPU 840, in FIG. 8 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 840 may include a network interface card (NIC) 842, a DDR memory 844, and a non-volatile memory express (NVMe) device 846. The NIC 842 may be able to interface with a network 804, which may also interface with additional NVMe devices available to the DPU 840, such as over fabric. In an embodiment, the DPU 840 may not include the NVMe device 846. In another embodiment, the NVMe device 846 may be located on the server 802 and not on the DPU 840. In yet another embodiment, the computing environment 800 may include more than one of the NVMe device 846, such as a first NVMe device in the DPU 840 and a second first NVMe device on the server 802 an associated directly with the PCIe switch 820. In an embodiment, the DPU 840 may not include the DDR memory 844 and may include a computational storage services (CSS) in place of, or in addition to, the DDR memory 844. For example, computing environment 800 may include DPU computational storage (CS) memory 806 available to the DPU 840 as part of the CSS. The network 804 may be able to interface with the DPU CS memory 806 through the NIC 842, according to any suitable interface protocol, such as remote direct memory access (RDMA) over Ethernet, InfiniBand, Fiber Channel, etc.

The total memory of the computing environment 800 available for data storage may be expanded through the use of the DPU 840 on nodes of the system. The DPU 840 may have access to a pool 850 of memory already available to the server 802, such as double data rate (DDR) memory, on-board NVMe devices, NVMe devices over fabric, and CS. The pool 850 of memory may include at least one of the DDR memory 844, NVMe 846, and the DPU CS memory 806. The DPU 840 may also be able to access the available memory of other DPUs as part of the pool 850, and other DPUs may be able to access the available memory of DPU 840, such as the pool 850. This available memory can be accessed and utilized for data storage, without the addition of compute resources, such as compute nodes, which would be required using other solutions. The available pool 850 accessible to the DPU 840 may be provisioned for the server 802 to expand the total memory available for data storage, such as to reduce the data storage load on the CPU 810 or the GPU 830, which can instead increase the utilization of their memory for processing. For example, during training of an AI, the model states, residual states, activation functions, and checkpoints can be stored, or offloaded, on the pool 850 accessible to the DPU 840.

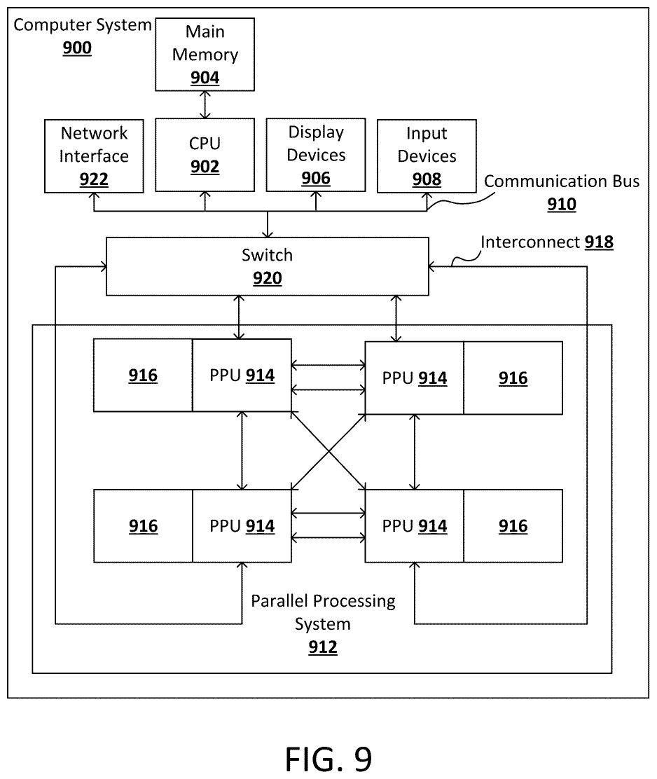

FIG. 9 illustrates a computer system 900, according to at least one embodiment. In at least one embodiment, computer system 900 is configured to implement various processes and methods described throughout this disclosure.

In at least one embodiment, computer system 900 comprises, without limitation, at least one central processing unit (“CPU”) 902 that is connected to a communication bus 910 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 900 includes, without limitation, a main memory 904 and control logic (e.g., implemented as hardware, software, or a combination thereof) and data are stored in main memory 904 which may take form of random access memory (“RAM”). In at least one embodiment, a network interface subsystem (“network interface”) 922 provides an interface to other computing devices and networks for receiving data from and transmitting data to other systems from computer system 900.

In at least one embodiment, computer system 900, in at least one embodiment, includes, without limitation, input devices 908, parallel processing system 912, and display devices 906 which can be implemented using a conventional cathode ray tube (“CRT”), liquid crystal display (“LCD”), light emitting diode (“LED”), plasma display, or other suitable display technologies. In at least one embodiment, user input is received from input devices 908 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 904 and/or secondary storage. Computer programs, if executed by one or more processors, enable system 900 to perform various functions in accordance with at least one embodiment. memory 904, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 902; parallel processing system 912; an integrated circuit capable of at least a portion of capabilities of both CPU 902; parallel processing system 912; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 900 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 912 includes, without limitation, a plurality of parallel processing units (“PPUs”) 914 and associated memories 916. In at least one embodiment, PPUs 914 are connected to a host processor or other peripheral devices via an interconnect 918 and a switch 920 or multiplexer. In at least one embodiment, parallel processing system 912 distributes computational tasks across PPUs 914 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 914, although such shared memory may incur performance penalties relative to use of local memory and registers resident to a PPU 914. In at least one embodiment, operation of PPUs 914 is synchronized through use of a command such as_syncthreads( ), wherein all threads in a block (e.g., executed across multiple PPUs 914) to reach a certain point of execution of code before proceeding.

Such components can be used in data centers that use liquid cooling systems.

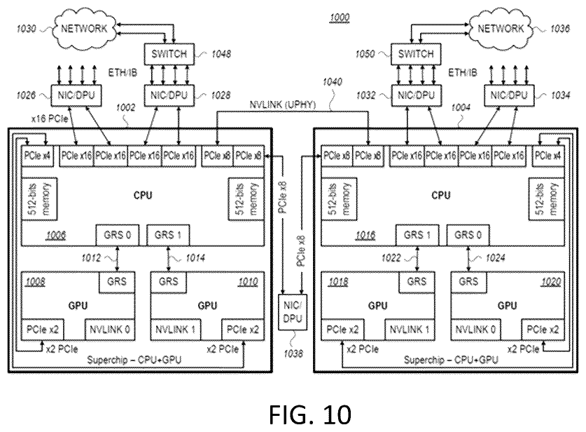

FIG. 10 is a block diagram that schematically illustrates a computing system 1000, e.g., a data center or a High-Performance Computing (HPC) cluster, in accordance with an embodiment that is described herein. System 1000 comprises a plurality of subsystems, e.g., multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 10 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 10, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 10, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 10 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034 and 1038, and/or any of switches 1048 and 1050, may use ILI packets in accordance with the techniques described herein. Such components can be used in data centers that use liquid cooling systems.

Various embodiments can be described by the following clauses:
1. A cooling fluid transport tubular, comprising:
a first layer forming a flow bore for the tubular;
a first sensing layer positioned radially outward from and coaxial with the first layer;
a dielectric layer positioned radially outward from and coaxial with the first sensing layer;
a second sensing layer positioned radially outward from and coaxial with the dielectric layer; and
a second layer positioned radially outward from and coaxial with the second sensing layer,
wherein a signal is generated responsive to a leak formed in the first layer.
2. The cooling fluid transport tubular of clause 1, wherein the first sensing layer and the second sensing layer are conductive materials.
3. The cooling fluid transport tubular of clause 1, wherein the dielectric layer is at least one of water soluble or water permeable.
4. The cooling fluid transport tubular of clause 1, wherein a first radial thickness of the first layer is less than a second radial thickness of the second layer.
5. The cooling fluid transport tubular of clause 1, wherein the first sensing layer, the second sensing layer, and the dielectric layer form a sensing zone of the cooling fluid transport tubular, further comprising:
a length extending from a first connection to a second connection;
wherein a plurality of sensing zones are arranged along the length of the cooling fluid transport tubular and at least a portion of the cooling fluid transport tubular does not include the sensing zone.
6. The cooling fluid transport tubular of clause 1, further comprising:
a third sensing layer positioned between the second sensing layer and the second layer; and
a second dielectric layer positioned between the third sensing layer and the second layer;
wherein a second signal is generated responsive to a second leak formed in the second layer as the leak migrates toward the third sensing layer.
7. The cooling fluid transport tubular of clause 1, further comprising: an electrical coupling connected to the first sensing layer and the second sensing layer.
8. A system, comprising:
a multi-layered tubular, comprising:
an inner containment layer;
an outer containment layer; and
a sensing stack between the inner containment layer and the outer containment layer; and
a controller to:
receive a signal from the sensing stack indicative of a change in condition;
determine the change in condition corresponds to a leak in the inner containment layer; and
generate an alert indicative of the leak.
9. The system of clause 8, wherein the sensing stack comprises:
an inner sensing layer;
a dielectric layer; and
an outer sensing layer;
wherein the inner sensing layer is positioned in contact with a first outer diameter of the inner containment layer, the dielectric layer is positioned in contact with a second outer diameter of the inner sensing layer, and the outer sensing layer is positioned in contact with a third outer diameter of the dielectric layer and an inner diameter of the outer containment layer.
10. The system of clause 9, wherein the dielectric layer is at least one of a water soluble layer or a water permeable layer.
11. The system of clause 9, wherein the inner sensing layer and the outer sensing layer are electrically conductive.
12. The system of clause 8, wherein the sensing stack has a shorter stack length than an inner containment layer length and an outer containment layer length.
13. The system of clause 12, further comprising:
a plurality of sensing stacks arranged along the inner containment layer length and the outer containment layer length, wherein respective stack lengths of the plurality of sensing stacks are not contiguous.
14. The system of clause 8, wherein a first radial thickness of the inner containing layer is less than a second radial thickness of the outer containing layer.
15. The system of clause 8, wherein the controller is further configured to: generate a task to inspect a rack region corresponding to a location of the multi-layered tubular.
16. The system of clause 15, wherein the controller is further configured to:
receive a leak indication corresponding to containment of the leak within the outer containment layer; and
generate a task to replace at least a portion of the multi-layered tubular during a maintenance window.
17. A cooling fluid hose for transporting a cooling fluid within a rack in a data center, the cooling fluid hose including a first containment layer, a second containment layer, and a leak sensing stack between the first containing layer and the second containment layer, wherein the leak sensing stack generates an electrical signal responsive to fluid interaction with the leak sensing stack.
18. The cooling fluid hose of clause 17, wherein the leak sensing stack is at least one of a capacitance sensor or a resistivity sensor.
19. The cooling fluid hose of clause 17, wherein the leak sensing stack forms a portion of a plurality of leak sensing stacks and each leak sensing stack of the plurality of leak sensing stacks is positioned separated from an adjacent leak sensing stack.
20. The cooling fluid hose of clause 17, wherein the electrical signal is indicative of a leak in the first containment layer.
21. A data center comprising:
one or more device racks; and
one or more cooling fluid hoses for transporting a cooling fluid within the device racks, the cooling fluid hoses including a first containment layer, a second containment layer, and a leak sensing stack between the first containing layer and the second containment layer, wherein the leak sensing stack generates an electrical signal responsive to fluid interaction with the leak sensing stack.
22. The data center of clause 21, wherein the electrical signal enables a controller having received the electrical signal to localize a region of the leak sensing stack of the cooling fluid hose.
23. The data center of clause 21, wherein the first containment layer may be configured to retain the cooling fluid if the second containment layer is breached.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU, DPU, QPU, a plurality of parallel processing units (PPUs). A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A cooling fluid transport tubular, comprising:
a first layer forming a flow bore for the tubular;
a first sensing layer positioned radially outward from and coaxial with the first layer;
a dielectric layer positioned radially outward from and coaxial with the first sensing layer;
a second sensing layer positioned radially outward from and coaxial with the dielectric layer; and
a second layer positioned radially outward from and coaxial with the second sensing layer,
wherein a signal is generated responsive to a leak formed in the first layer.

2. The cooling fluid transport tubular of claim 1, wherein the first sensing layer and the second sensing layer are conductive materials.

3. The cooling fluid transport tubular of claim 1, wherein the dielectric layer is at least one of water soluble or water permeable.

4. The cooling fluid transport tubular of claim 1, wherein a first radial thickness of the first layer is less than a second radial thickness of the second layer.

5. The cooling fluid transport tubular of claim 1, wherein the first sensing layer, the second sensing layer, and the dielectric layer form a sensing zone of the cooling fluid transport tubular, further comprising:
a length extending from a first connection to a second connection;
wherein a plurality of sensing zones are arranged along the length of the cooling fluid transport tubular and at least a portion of the cooling fluid transport tubular does not include the sensing zone.

6. The cooling fluid transport tubular of claim 1, further comprising:
a third sensing layer positioned between the second sensing layer and the second layer; and
a second dielectric layer positioned between the third sensing layer and the second layer;
wherein a second signal is generated responsive to a second leak formed in the second layer as the leak migrates toward the third sensing layer.

7. The cooling fluid transport tubular of claim 1, further comprising:
an electrical coupling connected to the first sensing layer and the second sensing layer.

8. A system, comprising:
a multi-layered tubular, comprising:
an inner containment layer;
an outer containment layer; and
a sensing stack between the inner containment layer and the outer containment layer; and
a controller to:
receive a signal from the sensing stack indicative of a change in condition;
determine the change in condition corresponds to a leak in the inner containment layer; and
generate an alert indicative of the leak.

9. The system of claim 8, wherein the sensing stack comprises:
an inner sensing layer;
a dielectric layer; and
an outer sensing layer;
wherein the inner sensing layer is positioned in contact with a first outer diameter of the inner containment layer, the dielectric layer is positioned in contact with a second outer diameter of the inner sensing layer, and the outer sensing layer is positioned in contact with a third outer diameter of the dielectric layer and an inner diameter of the outer containment layer.

10. The system of claim 9, wherein the dielectric layer is at least one of a water soluble layer or a water permeable layer.

11. The system of claim 9, wherein the inner sensing layer and the outer sensing layer are electrically conductive.

12. The system of claim 8, wherein the sensing stack has a shorter stack length than an inner containment layer length and an outer containment layer length.

13. The system of claim 12, further comprising:
a plurality of sensing stacks arranged along the inner containment layer length and the outer containment layer length, wherein respective stack lengths of the plurality of sensing stacks are not contiguous.

14. The system of claim 8, wherein a first radial thickness of the inner containing layer is less than a second radial thickness of the outer containing layer.

15. The system of claim 8, wherein the controller is further configured to:
generate a task to inspect a rack region corresponding to a location of the multi-layered tubular.

16. The system of claim 15, wherein the controller is further configured to:
receive a leak indication corresponding to containment of the leak within the outer containment layer; and
generate a task to replace at least a portion of the multi-layered tubular during a maintenance window.

17. A cooling fluid hose for transporting a cooling fluid within a rack in a data center, the cooling fluid hose including a first containment layer, a second containment layer, and a leak sensing stack between the first containing layer and the second containment layer, wherein the leak sensing stack generates an electrical signal responsive to fluid interaction with the leak sensing stack.

18. The cooling fluid hose of claim 17, wherein the leak sensing stack is at least one of a capacitance sensor or a resistivity sensor.

19. The cooling fluid hose of claim 17, wherein the leak sensing stack forms a portion of a plurality of leak sensing stacks and each leak sensing stack of the plurality of leak sensing stacks is positioned separated from an adjacent leak sensing stack.

20. The cooling fluid hose of claim 17, wherein the electrical signal is indicative of a leak in the first containment layer.

21. A data center comprising:
one or more device racks; and
one or more cooling fluid hoses for transporting a cooling fluid within the device racks, the cooling fluid hoses including a first containment layer, a second containment layer, and a leak sensing stack between the first containing layer and the second containment layer, wherein the leak sensing stack generates an electrical signal responsive to fluid interaction with the leak sensing stack.

22. The data center of claim 21, wherein the electrical signal enables a controller having received the electrical signal to localize a region of the leak sensing stack of the cooling fluid hose.

23. The data center of claim 21, wherein the first containment layer may be configured to retain the cooling fluid if the second containment layer is breached.
